(19) United States
(12) Patent Application Publication
(10) Pub. No.: US 2025/0285481 A1
(43) Pub. Date: Sep. 11, 2025

(54) Composite Identifiers for Wearable Articles

(71) Applicant: ZEBRA TECHNOLOGIES CORPORATION, Lincolnshire, IL (US)

(72) Inventor: James J. O'Hagan, McHenry, IL (US)

(21) Appl. No.: 18/597,565

(22) Filed: Mar. 6, 2024

(51) Int. Cl. G07C 9/20

(52) U.S. Cl. CPC G07C 9/20

(57) ABSTRACT

An article includes: a first portion having a first graphic; a second portion having a second graphic, the second portion being translucent; a body extending between the first portion and the second portion, the body being deformable to affix the second portion at a position overlaid with the first portion, wherein the second graphic is configured to overlay with the first graphic to define a composite graphic corresponding to the position.

### BACKGROUND

Controlling access to physical facilities, services such as software accessed via computing devices, or the like, may involve identifying each party seeking to access the facility and/or service uniquely from other parties. In some environments, the provision of unique identifiers to potentially large numbers of such parties may be costly and/or time-consuming.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for managing access to an access-controlled resource.

FIG. 2A is a diagram of an identification article in the system of FIG. 1.

FIG. 2B is a cross-section of the article of FIG. 2A.

FIG. 2C is an assembled view of the article of FIG. 2A.

FIG. 3 is a diagram of detailed views of the first and second graphics of the article of FIG. 2A.

FIGS. 4A, 4B, and 4C are diagrams of distinct composite graphics generated by the article of FIG. 2A.

FIG. 5 is a diagram illustrating the generation of a unique identifier from the composite graphics shown in FIGS. 4A-4C.

FIG. 6 is a flowchart of an authentication method using the identifiers generated as illustrated in FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to an article, comprising: a first portion having a first graphic; a second portion having a second graphic, the second portion being translucent; a body extending between the first portion and the second portion, the body being deformable to affix the second portion at a position overlaid with the first portion, wherein the second graphic is configured to overlay with the first graphic to define a composite graphic corresponding to the position.

Additional examples disclosed herein are directed to a method, comprising: capturing an image of an article having a first graphic overlaid with a second graphic to define a composite graphic, the composite graphic including a boundary of the second graphic, marks of the second graphic, and a portion of a plurality of marks of the first graphic; detecting, from the image, the boundary of the second graphic; generating an identifier based on the composite graphic; and executing an authentication action based on the identifier.

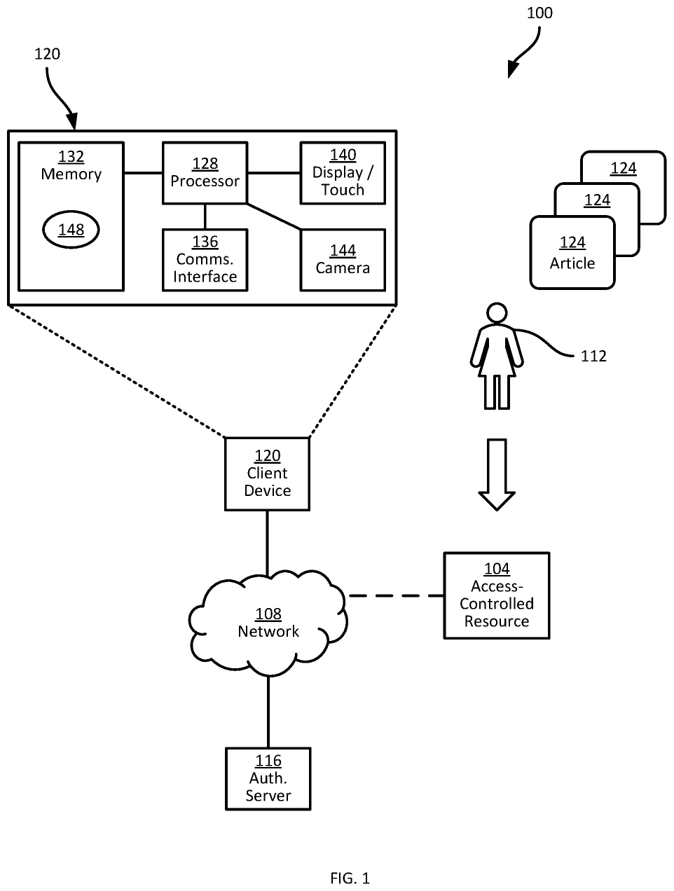

FIG. 1 shows a system 100 for managing access to an access-controlled resource 104. The resource 104 can be an enterprise software application hosted on one or more computing devices, e.g., connected with a network 108. In other examples, the resource 104 can be a facility (e.g., a building, complex of buildings, or the like), such as a healthcare facility, an entertainment venue, or the like. A person 112, e.g., a patient or staff member at healthcare facility, an employee at a warehouse, an attendee at an entertainment venue or the like, may be permitted to access the resource 104 upon completing an authentication process, e.g., implemented by an authentication server 116 that can be implemented as a computing device connected with the network 108.

The authentication server 116 can, for example, store a plurality of account records each corresponding to distinct individuals. Each account record can include various information corresponding to a given person, such as an account name and/or other identifier, a secret such as a password and/or encryption key, and the like. The authentication process serves to determine whether a person purporting to be a holder of an account maintained at the server 116 is truly the account holder.

Some authentication processes involve the provision of an account identifier and password by the person 112 to the server 116, e.g., via a client computing device 120 operated by the person 112. Certain authentication processes involve the provision of additional information, such as biometric authentication, a personal identification number (PIN), a message from a further computing device also operated by the person 112, or the like.

Other authentication processes may involve assigning a unique identifier to the person 112, and subsequently verifying that the person 112 is in possession of that unique identifier. The unique identifier can be provided to the person 112, for example, in the form of a wristband or other wearable article that carries the unique identifier, e.g., in the form of a barcode or other machine-readable form. A unique identifier can also be used to supplement other authentication processes, for example to facilitate re-authentication by the person 112 and thereby regain access to the resource 104 without repeating the provision of an account identifier, password, biometric data, or the like. That is, in an initial authentication process the person 112 may supply authentication data such as an account identifier and a password, as well as the unique identifier, and subsequently (e.g., for a time period determined at the server 116) the person 112 may regain access to the resource 104 by presenting the unique identifier without account identifiers, passwords, and the like.

Although the use of a unique identifier may reduce the time spent by the person 112 to authenticate with the server 116 and gain access to the resource 104, providing unique identifiers within the system 100 may be costly and/or time-consuming. For example, in some systems unique identifiers may be predetermined and stored at the server 116, as well as deployed to users of the system 100 (such as the person 112) via distinct physical tokens, such as wristbands with barcodes or the like each encoding distinct identifiers. The generation and storage of unique identifiers, as well as the manufacturing, deployment, and securing of physical tokens with distinct identifiers, can be costly.

To mitigate the impact of deploying individually-assigned unique identifiers for users of the system 100 such as the person 112, the system 100 includes a plurality of articles 124 that need not encode any specific identifier in an initial state. In some examples, the articles 124 can be substantially identical to one another in an initial state, e.g., prior to use by the person 112. The articles 124 are configured to dynamically generate unique identifiers when used, as discussed below. The articles 124 can be manufactured in bulk, without any predetermination of unique identifiers, and supplied to a facility or other location where the person 112 and other users of the system 100 seek access to the resource 104. Upon use, each article 124 can dynamically generate a unique identifier that distinguishes that article 124 from the other articles 124. The dynamically generated unique identifier can be used for a variety of purposes, including enrollment at the server 116 in association with the person 112 (e.g., via the client computing device 120) and subsequent use to grant access to the resource 104 for the person 112.

Certain components of the client device 120 are illustrated in FIG. 1. The client device 120 includes a processor 128 (e.g., a CPU, GPU, and/or other suitable control circuitry, microcontroller, or the like), and a non-transitory computer-readable medium such as a memory 132. The client device 120 also includes a communications interface 136 configured to communicate with other computing devices via the network 108, such as the authentication server 116 and, in embodiments where the resource 104 is a hosted application, the resource 104. In an embodiment, the resource 104 is an access-controlled application server configured to accept data captured by the client device 120.

The client device 120 may further include one or more input devices 140 and one or more output devices, such as a display and touch screen assembly. The client device 120 can include other input/output devices, such as speakers, microphones, keypads, barcode scanners, radio frequency identification (RFID) readers, and the like. The client device 120 also includes a camera 144. As discussed below, the camera 144 can be controlled to capture an image of an article 124, and determine a unique identifier for the article 124. The unique identifier can be enrolled with the server 116 for later use in authenticating or re-authenticating the person 112, for example. The memory 132 can store computer-readable instructions, e.g., including an authentication application 148, executable by the processor 128 to implement functions related to the capture and processing of images of the articles 124 to derive unique identifiers. In an embodiment, the camera 144 may also function as an input/output device 140.

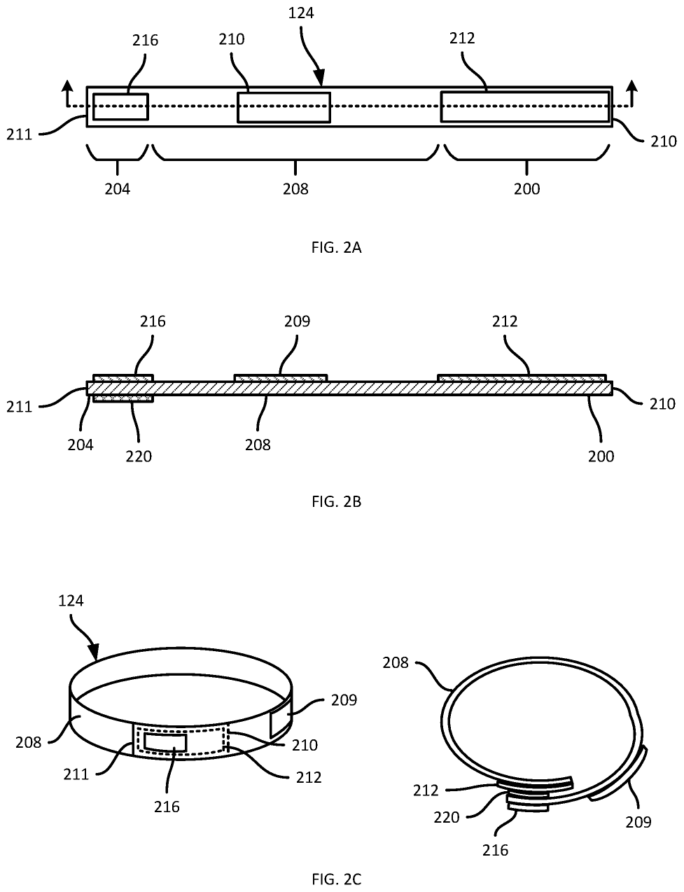

Turning to FIGS. 2A, 2B, and 2C, an example article 124 is shown. The article 124 in the illustrated example is a wristband, although the articles 124 can take other forms in addition to or instead of wristbands. Other example form factors for the articles 124 include arm bands, belts, lanyards, plant tags, and the like. It is also contemplated that while the articles 124 are discussed herein in the context of providing identifiers for users of the system 100 such as the person 112, the articles 124 can also be employed to identify objects such as parcels, animals, machinery components, trees, plants, or the like.

The article 124, as shown in FIG. 2A, includes a first portion 200, a second portion 204, and a body 208 extending between the first and second portions. In this example, the first portion 200, the second portion 204, and the body 208 are formed from a single piece of material, e.g., a suitable wristband substrate such as a flexible polymer. In other examples, any one of, or any combination of, the portions 200 and 204 and the body 208, can be formed from distinct materials joined together by adhesives or other suitable fasteners. In some examples, the body 208 can include additional components, such as a bracket or other support for an identification tag, a coating of material configured for printing of indicia thereon, or the like. The body 208 can, in other words, support a data carrier 209 such as an RFID tag, a barcode, a label including text, images, or the like. The data carrier 209 can be disposed on an outer surface of the body 208, as illustrated, or can be integrated within the substrate forming the body 208. The data carrier 209 can store, encode, and/or display a unique identifier, for example. In an embodiment when the article is used, the body 208 may be configured to support an active radio frequency identification tag, such as an ultrawideband location tag or a Bluetooth low energy (BLE) tag.

The first portion 200, in the illustrated example, is disposed at a first end 210 of the article 124, and the second portion 204 is disposed at an opposite end 211 of the article 124. Further, the first portion 200 includes a first graphic 212, and the second portion 204 includes a second graphic 216. As seen in the cross-sectional view of FIG. 2B, the graphics 212 and 216 can be formed on the substrate material defining the body 208 and the portions 200 and 204 as a coating of ink or other pigment (the thickness of which is exaggerated in FIG. 2B for illustration). In other examples, the graphics 212 and 216 can be embedded within the substrate material.

In the illustrated example the article 124 further includes a fastener, such as an adhesive 220, shown in FIG. 2B on an opposite side of the portion 204 from the graphic 216. The adhesive 220 permits the second portion 204 to be affixed to the first portion 200. In particular, in the illustrated configuration, the body 208 can be deformed, e.g., to encircle a wrist of the person 112, and the adhesive 220 can be placed over the first portion 200 to form the article 124 into a loop.

The adhesive 220, in other words, can be placed onto the graphic 212, such that the second portion, including the second graphic 216, is overlaid on the first graphic 212, as shown in FIG. 2C. While the first portion 200 and the first graphic 212 are covered by the second portion 204, as indicated by dashed lines in FIG. 2C, at least the portion 204 of the article 124 is translucent and the first graphic 212 remains visible through the second portion 204. In some examples, the substrate (e.g., the body 208 and the portions 200 and 204) is translucent or transparent. In other examples, the portion 204 is translucent or transparent, while the body 208 and the portion 200 can be opaque. That is, the portion 204 and the adhesive 220 permit the passage of sufficient light (e.g., visible light) therethrough for an image (e.g., captured by the camera 144) depicting the article 124 in an assembled configuration as shown in FIG. 2C to show the second graphic 216, and at least a portion of the first graphic 212 underneath the second graphic 216. The second graphic 216 and the overlaid portion of the first graphic 212 form a composite graphic that can be employed, e.g., by the client device 120, to generate an identifier for the article 124. FIG. 2C also illustrates the article 124 in an overhead view, showing the graphics 212 and 216 and the adhesive 220 in an assembled configuration. The thickness of the graphics 212 and 216, and the adhesive 220, are exaggerated for illustrative purposes.

In some examples, the adhesive 220 need not be transparent, but can instead be disposed at either end of the second portion 204, rather than directly underneath the second graphic 216. In further examples, the second graphic 216 can be defined by pigmented adhesive, such that a single coating in the position of the adhesive 220 as shown in FIG. 2B can provide both the second graphic 216 and the adhesive 220.

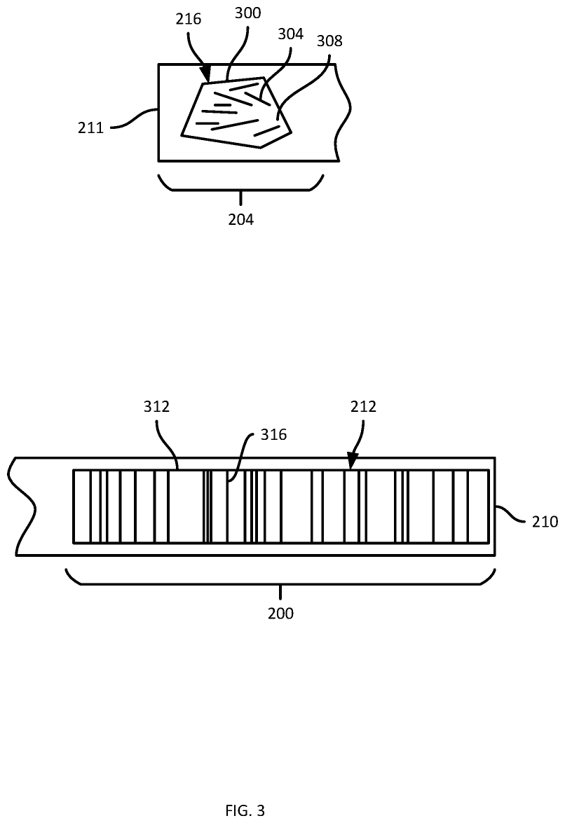

Turning to FIG. 3, the first and second graphics 212 and 216 are shown in greater detail. The second graphic 216 can have a surface area that is smaller than a surface area of the first graphic 212. The second graphic 216 further includes a boundary 300, such as a solid line in this example. In other examples, the boundary 300 can be defined as a set of concentric arcs, as a dashed line, or the like. In an example, the boundary 300 is a set of three or more connected line segments of different lengths, where the ratio of the length of two segments is an integer. The second graphic further includes a plurality of marks 304, such as line segments at various angles of orientation. The second graphic 216 can include a wide variety of other forms of marks, such as dots, polygons, zebra stripes, and the like. The second graphic 216 further includes a background 308 (e.g., the portion of the second graphic 216 within the boundary 300 and not occupied by the marks 304) that is translucent or transparent. The boundary 300 and the marks 304 can be opaque.

The first graphic 212 can include a boundary 312, such as a solid line, a dashed line, a set of concentric arcs, or the like. In some examples, the boundary 312 can be omitted. Within the boundary 312, the first graphic 212 includes a plurality of marks 316, which in the illustrated example are lines extending from one side of the boundary 312 to an opposite side of the boundary 312, substantially perpendicular to the edges of the article 124. The marks 316 can have a variety of other angles than those shown, and need not be at the same angles. The marks can also include dots, polygons, zebra stripes, or the like. In some examples, such as that shown in FIG. 3, the marks 304 are oriented within a threshold angle (e.g., thirty degrees, though other thresholds are also contemplated) of the edges of the article 124, while the marks 316 are oriented within a threshold angle (e.g., one hundred twenty degrees, though other thresholds are also contemplated) of the ends 210 and 211 of the article 124. The marks 304 are therefore more likely to be perpendicular to the marks 316 than parallel when the article 124 is assembled for use. When the second graphic 216 is overlaid on the first graphic 212, intersections between marks 304 and marks 316 are likely to result. Such intersections may facilitate the generation of a unique identifier for the article 124.

The second graphic 216 can have a predefined color (e.g., red, in some examples, although any of a wide variety of colors can be employed), and can also include various other predetermined attributes, such as predefined dimensions for the sides of the boundary 300. The first graphic 212 can also have a predefined color, e.g., different from the color of the second graphic 216 (e.g., cyan, in some examples). In other examples, each graphic 212 and 216 can include more than one color. The provision of distinct colors for the graphics 212 and 216, or in some examples for at least the boundary 300, may facilitate the detection of the boundary 300 within an image of the article 124.

When the body 208 of the article 124 is deformed to affix the second portion 204 to the first portion 200, the specific location of the second graphic 216 relative to the larger first graphic 212 is variable, e.g., depending on a size of the resulting loop formed by the article 124, as well as the angle at which the ends of the article 124 are aligned before affixing the second portion 204 to the first portion 200. For example, a person with a smaller wrist may affix the second portion 204 at a different position on the first portion 200 than a person with a larger wrist.

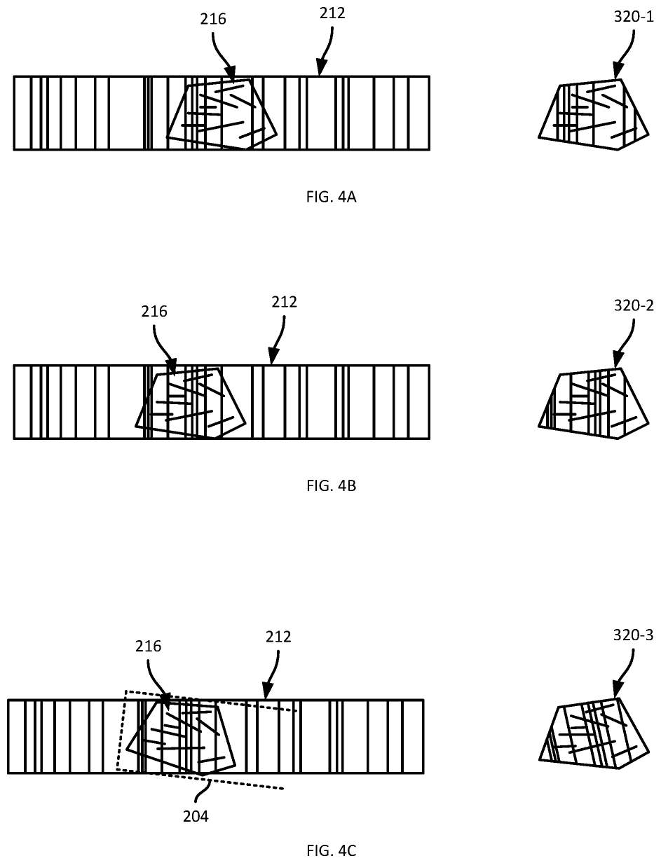

Turning to FIGS. 4A, 4B, and 4C, affixing the second portion 204 at a given position relative to the first portion 200 generates one of a plurality of composite graphics 320. Three example composite graphics 320-1, 320-2, and 320-3 are shown in FIGS. 4A, 4B, and 4C, and are collectively referred to as composite graphics 320, or generically as a composite graphic 320. The composite graphics 320 are defined by the boundary 300, the marks 304, and a subset of the marks 316 that appear within the boundary 300.

As shown in FIG. 4A, affixing the second portion 204 at a first position relative to the first portion 200 generates a composite graphic 320-1, containing certain ones of the marks 316. As shown in FIG. 4B, affixing the second portion 204 at another position relative to the first portion 200 generates a different composite graphic 320-2, containing a different subset of the marks 316 than the composite graphic 320-1. FIG. 4C shows a further example, in which the second portion 204 is affixed to the first portion 200 at an angle (that is, the first and second portions 200 and 204 are not substantially parallel, as in FIGS. 4A and 4B). The position shown in FIG. 4C yields a further composite graphic 320-3. The composite graphic 320-3 contains the same subset of the marks 316 as the composite graphic 320-2, but that subset of marks 316 is oriented differently in the composite graphic 320-3 than in the composite graphic 320-2.

It will be understood that the second portion 204 can be affixed to the first portion 200 in a wide variety of other positions, each yielding a distinct composite graphic 320. A single article 124 can, in other words, generate any of a wide variety of composite graphics 320, and thus a supply of initially identical articles 124 can generate a plurality of distinct identifiers.

The use of a fastener such as the adhesive 220 may prevent the relative positions of the first and second graphics 212 and 216 from changing after the second portion 204 is affixed to the first portion 200. The article 124, in other words, can generate one of a variety of composite graphics, and that composite graphic is then unlikely to change. The composite graphic can be used to generate a substantially unique identifier for the article 124. Therefore, a plurality of articles 124 that initially (e.g., before use) are substantially identical can generate, when worn by users such as the person 112, a plurality of different identifiers that can then be used for authentication or other identification functions. In embodiments employing adhesives as fasteners, returning the article 124 to an initial state, in which the first and second portions 200 and 204 are no longer overlaid, may be impossible, or may damage the article 124. The article 124, in other words, may be tamper-evident. Further, removal of the article 124 by stretching and/or disengagement of the adhesive 220 destroys the composite graphic 320, and recreating a substantially identical composite graphic 320 may be difficult or impossible.

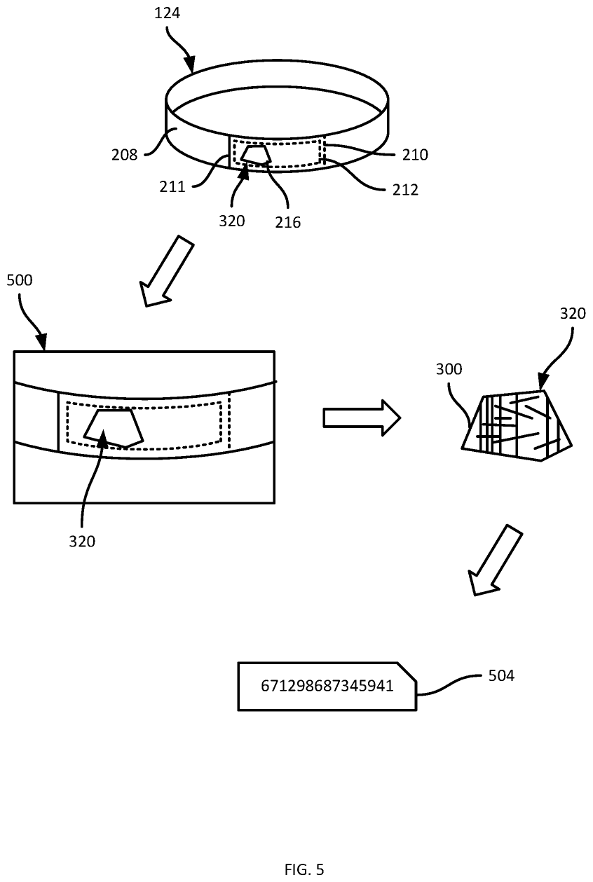

Turning to FIG. 5, the generation of a unique identifier from an article 124 is discussed in greater detail. The generation of the unique identifier can be performed, for example, by the client device 120 via execution of the application 148. The client device 120 can be controlled, e.g., by the person 112 or another operator, to place at least a portion of the article 124 bearing the composite graphic 320 within a field of view of the camera 144. Via the camera 144, the client device 120 can capture an image 500 of the article 124, depicting the composite graphic 320. The client device 120 can be configured to detect the boundary 300 in the image 500, e.g., based on predefined dimensions of the sides of the boundary, the color of the boundary, the relative size of portions of the boundary 300, and the like. In an embodiment, a trained computer vision model may detect the boundary 300. The client device 120 can be configured to extract the composite graphic 320 from the image 500 based on the detected boundary 300 (e.g., by discarding any portion of the image 500 that is outside the boundary 300).

The client device 120 can then be configured to generate a unique identifier 504, e.g., in the form of a numerical representation of a set of features of the composite graphic 320. Various mechanisms can be employed to generate the identifier 504. For example, the client device 120 can detect intersections between the marks 304 and 316. In other examples, the client device 120 can detect corners or other keypoints within the composite graphic 320, e.g., via the Scale-invariant Feature Transform (SIFT) keypoint detector algorithm or any other suitable keypoint detector. The keypoints selected by the client device 120 may be substantially invariant to scale, orientation, and lighting artifacts, to permit later detection in distinct images of the article 124.

The client device 120 can then determine, for each keypoint, a numerical representation such as a binary descriptor vector. Various descriptor generation mechanisms can be employed for this purpose, including for example the Oriented FAST and Rotated BRIEF (ORB) descriptor. The ORB descriptor operates on intensity values and can therefore include converting the composite graphic 320 to grayscale, but the client device 120 can also implement other descriptor generation mechanisms that operate on color images. In an embodiment where a first graphic 212 is red and a second graphic 216 is cyan, the descriptor mechanism may operate on a first monochrome (cyan) color plane to describe attributes of the second graphic and a second color plane to describe related attributes of the composite image. Generating a binary descriptor can include, for a given keypoint (e.g., a specific pixel or a patch of pixels), sampling a plurality of pixel pairs of the composite graphic 320 within or around the keypoint (e.g., sampling from a 15×15 pixel grid surrounding the center of the keypoint). For each pair, a binary value is selected based on whether the first pixel in the pair has a higher or lower intensity than the second pixel in the pair. The descriptor for the keypoint is therefore a vector of binary values. The identifier 504 can therefore be a combination of each keypoint descriptor vector, e.g., in the form of a one-dimensional or multi-dimensional array of numerical values. For example, the client device 120 may select fifty keypoints, generate a 256-bit descriptor vector for each keypoint, and concatenate the descriptor vectors to generate the identifier 504. A wide variety of other forms of identifier 504 can also be employed, however.

In some examples, the client device 120 can perform additional processing on the composite graphic 320 to generate the identifier 504. For example, the client device 120 can adjust color and/or intensity values of the composite graphic 320 to calibrate the boundary 300, marks 304, and marks 316 to predetermined colors (e.g., red and cyan, as mentioned earlier) before generating the identifier 504. The background color between the marks 304 and 316, which may represent clothing or skin of the person 112, may therefore also contribute to the identifier 504 in a way that is reproducible under different imaging conditions. In an example where the article 124 is assembled around an appendage (e.g., a wrist or ankle) of a human person 112, skin that is visible within the background area 308 of the composite mark will be a human skin tint within a cyan-red colorspace; in this example a red first mark with a cyan second mark may define a composite identifier, while the red and cyan layers may be used to calibrate a colorspace such that the tint may be quantified within the cyan-red colorspace. That tint may then be used as a biometric identifier for the wearer 110 of the article 124. For example, in addition to identifying the boundary 300, the marks 304, and the marks 316, the device 120 can identify the background 308, determine a color value of the background 308 (e.g., after calibration as noted above), and store the determined color value as a component of the identifier derived from the composite graphic 320 or as an independent identifier. In other examples, the device 120 can identify the boundary 300, marks 304, and marks 316, and discard (e.g., overwrite with white, black, or the like) any other pixels prior to generating the identifier 504.

By applying the same keypoint detection and descriptor generation mechanisms, the client device 120, and/or other computing devices, can capture subsequent images of the article 124 and generate identifiers therefrom that either match the identifier 504, or are sufficiently close to the identifier 504 to indicate a high likelihood that the same article 124 is represented in the subsequent images as in the image 500. In other words, an identifier that differs from the identifier 504 by more than a threshold is likely to correspond to a distinct article 124.

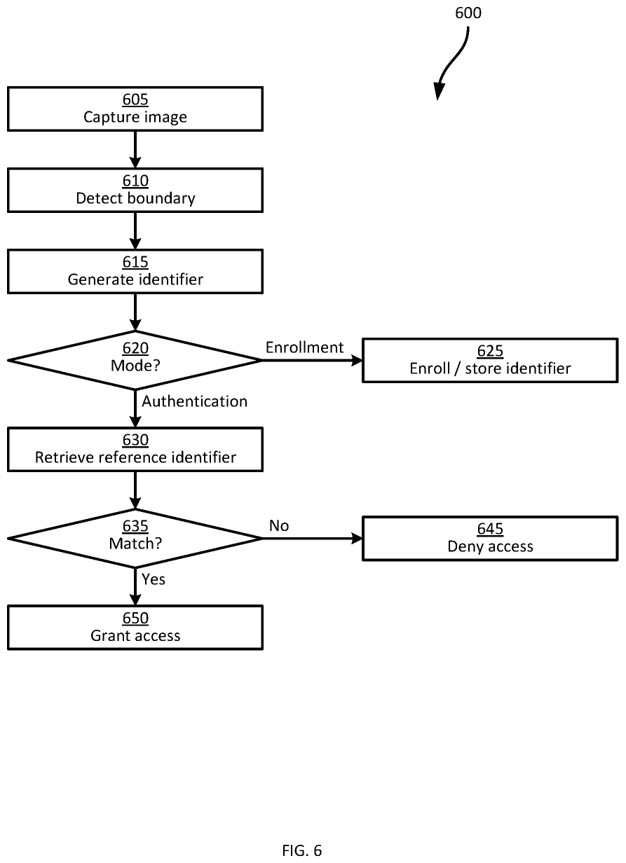

Turning to FIG. 6, a method 600 is illustrated, e.g., performed by the client device 120 to employ articles 124 for authenticating the person 112 and/or other users of the system 100. At block 605, the device 120 can capture an image, such as the image 500 discussed in connection with FIG. 5. At block 610, the device 120 can detect the boundary 300 of the second graphic 216, and extract the composite graphic 320 from the image 500. At block 615, the device 120 can generate the identifier 504 based on the composite graphic 320, as also discussed in connection with FIG. 5. The identifier generated at block 615 can include, in some examples, generating a color value based on the background 308 and corresponding to the skin of the wearer of the article 124.

Once the device 120 has generated the identifier 504, the device 120 can perform one or both of an enrollment function and an authentication function (which may be referred to collectively as authentication actions), e.g., depending on a mode of operation selected by the person 112 or another operator of the device 120. At block 620, the device 120 can select an operating mode, or receive input data selecting an operating mode.

For example, in the enrollment mode, the identifier 504 may not have been previously associated with the person 112, and therefore at block 625 the device 120 can collect and transmit and/or store authentication data in association with the identifier 504. For example, enrollment can include capturing biometric data of the person 112, prompting the person 112 for an account name and password, or the like (collectively, referred to as authentication data), and transmitting the authentication data and the identifier 504 to the server 116.

In the authentication mode, rather than enrolling a new identifier in association with the person 112, the device 120 can be configured to determine whether the identifier from block 615 matches a previously enrolled identifier. At block 630, the device 120 can retrieve a reference identifier, e.g., via a search of a repository of previously enrolled identifiers stored at the server 116 or the like. When a matching reference identifier is located that is sufficiently similar to the identifier from block 615, the determination at block 635 is affirmative, and at block 650 the client device 120 can grant access to the resource 104. When no matching reference identifier is located that matches the identifier from block 615, the device 120 can instead deny access at block 645. The determination at block 635 can include, for example, computing a cosine similarity between numerical vectors representing the identifier from block 615 and the reference identifier. Other suitable matching mechanisms will also occur to those skilled in the art. The device 120 (or the server 116) can apply a threshold, e.g., such that the reference identifier need not match the identifier from block 615 exactly to result in an affirmative determination at block 635.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An article, comprising:
a first portion having a first graphic;
a second portion having a second graphic, the second portion being translucent; and
a body extending between the first portion and the second portion, the body being deformable to affix the second portion at a position overlaid with the first portion, wherein the second graphic is configured to overlay with the first graphic to define a composite graphic corresponding to the position.

2. The article of claim 1, wherein the composite graphic is imageable to generate a unique identifier corresponding to the article.

3. The article of claim 1, wherein the article is a wristband having the first portion at a first end of the body, and the second portion at an opposing end of the body.

4. The article of claim 3, further comprising: a translucent adhesive disposed on one of the first portion and the second portion, to affix the second portion to the first portion.

5. The article of claim 1, wherein
the first graphic has a first surface area;
the second graphic has a second surface area smaller than the first surface area; and
the composite graphic is defined by a location of the second graphic within the first surface area.

6. The article of claim 1, wherein:
the second graphic includes a boundary;
the first graphic includes a plurality of marks; and
the composite graphic is defined by a subset of the plurality of marks of the first graphic encompassed by the boundary.

7. The article of claim 6, wherein
the second graphic includes a second plurality of marks within the boundary; and
the composite graphic is further defined by intersections between the marks of the second graphic and the subset of the plurality of marks of the first graphic.

8. The article of claim 1, wherein the first graphic has a first color, and the second graphic has a second color distinct from the first color.

9. The article of claim 1, further comprising: a data carrier supported by the body.

10. A method, comprising:
capturing an image of an article having a first graphic overlaid with a second graphic to define a composite graphic, the composite graphic including a boundary of the second graphic, marks of the second graphic, and a portion of a plurality of marks of the first graphic;
detecting, from the image, the boundary of the second graphic;
generating an identifier based on the composite graphic; and
executing an authentication action based on the identifier.

11. The method of claim 10, wherein executing the authentication action includes:
enrolling the identifier; or
retrieving a reference identifier, and comparing the reference identifier with the identifier.

12. The method of claim 10, wherein generating the identifier includes:
detecting a background within the boundary of the second graphic; and
generating a color value corresponding to the background.

13. The method of claim 12, further comprising:
calibrating the image based on a first predetermined color corresponding to the first graphic, and a second predetermined color corresponding to the second graphic; and
generating the color value in response to calibrating the image.
